(19) United States
(12) Patent Application Publication
(10) Pub. No.: US 2015/0176822 A1
(43) Pub. Date: Jun. 25, 2015

(54) LIGHT REFLECTOR CLAMP

(71) Applicant: CHIEN-TING LIN, Santa Fe Springs, CA (US)

(72) Inventor: CHIEN-TING LIN, Santa Fe Springs, CA (US)

(21) Appl. No.: 14/139,795

(22) Filed: Dec. 23, 2013

(51) Int. Cl. F21V 21/088

(52) U.S. Cl. CPC F21V 21/088

(57) ABSTRACT

The present invention provides a light reflector clamp for mounting a light reflector with a rod member. The light reflector clamp of the present invention includes a central member, a groove and a turning clamp set. A rod member clamping seat is disposed on the central member, and a mounting portion is disposed at an opening of the rod member clamping seat. The groove is disposed on the central member, and the turning clamp set is disposed on the central member next to the groove. At least one of the light reflector clamp is mounted on the rod member via the rod member clamping seat. An edge of the light reflector is fitted in the groove, and at least one of the turning clamp set is utilized to fix the edge of the light reflector with the at least one light reflector clamp.

### BACKGROUND OF THE INVENTION

1. Field of the Invention

The present invention relates to a light reflector clamp used in photographing and video recording. More particularly, the present invention is a light reflector clamp with a turning clamp set, which can be used to mount a light reflector with a rod member.

2. the Prior Arts

Light reflector is a type of auxiliary lighting tool used to reflect light, and is frequently used in photographing and video recording. When light reflectors are used during photographing or video recording, the colors of the photographs or videos are more enriched, and the photos or videos can be presented in a more stereoscopic manner. Light reflector can also be used to partially reflect light, so only the details in a certain portion of the photos or videos are clearer. In addition, the complementary effect created by the light reflector is softer, and is quite different from the sharpness created by using flash lights.

Conventionally, a light reflector is mounted with a rod member using ropes or tapes. However, these two mounting methods are very unstable and difficult to practice. The light reflector mounted with a rod member using ropes or tapes can be affected by external environment and fall off easily. Another way of mounting a light reflector with a rod member is using a spring clamp. Such spring clamps are exclusive for mounting the light reflector with rod members; however, due to the shape of spring clamps, light reflectors can be damaged, thereby lowering the durability of the alight reflectors. There is another type of light reflector clamp which clamps the light reflector with two grooves configured on two separate clamping units. When using such clamps, the two separate clamping units need to be aligned precisely, thereby raising the difficulty of the assembling process. In addition, because the clamps is mounted on the light reflector by abutting the two grooves against the light reflector, if the two clamping units are not aligned in a precise manner, the light reflector can fall off easily.

### SUMMARY OF THE INVENTION

Based on the above reasons, a primary objective of the present invention is to provide a light reflector clamp used in photographing and video recording, which can be mounted with a rod member quickly and stably without damaging the light reflector.

In order to fulfill the above objectives, a light reflector clamp is provided in the present invention. The light reflector clamp can be used to mount a light reflector with a rod member. The light reflector clamp of the present invention includes a central member, a groove and a turning clamp set. A rod member clamping seat is disposed on the central member, and a mounting portion is disposed at an opening of the rod member clamping seat. The groove is disposed on the central member, and the turning clamp set is disposed on the central member next to the groove. At least one of the light reflector clamp is mounted on the rod member via the rod member clamping seat. An edge of the light reflector is fitted in the groove, and at least one of the turning clamp set is utilized to fix the edge of the light reflector with the at least one light reflector clamp.

With the turning clamp set and the groove provided by the present invention, the light reflector can be easily and quickly mounted with the rod member, and the damage to the light reflector can be minimized.

Comparing with the conventional mounting methods and the conventional clamps, the engagement provided by the present invention between the light reflector and the rod member is more stable, and the mounting process is also easier. On the other hand, when compared with the conventional spring clamps, the light reflector clamp provided by the present invention is less likely to damage the light reflector during the mounting process. When compared with the conventional two-pieces clamps, the light reflector clamp provided by the present invention does not require precise alignment and therefore the mounting process thereof is easier. The clamp provided by the present invention is also less likely to fall off. In addition, the clamp provided by the present invention can also be used to mount electric wire sets. The conventional clamps do not provide such function.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view showing a light reflector clamp according to the present invention;

FIG. 2 is an exploded view showing the light reflector clamp according to the present invention;

FIG. 3 is a section view showing the light reflector clamp according to the present invention;

FIG. 4 is a perspective view showing a light reflector clamp according to a first embodiment of the present invention;

FIG. 5 is a perspective view showing a light reflector clamps according to a second embodiment of the present invention; and

FIG. 6 is a perspective view showing a light reflector clamp according to a third embodiment of the present invention.

### DETAILED DESCRIPTION OF THE PREFERRED EMBODIMENTS

The accompanying drawings are included to provide a further understanding of the invention, and are incorporated in and constitute a part of this specification. The drawings illustrate embodiments of the invention and, together with the description, serve to explain the principles of the invention.

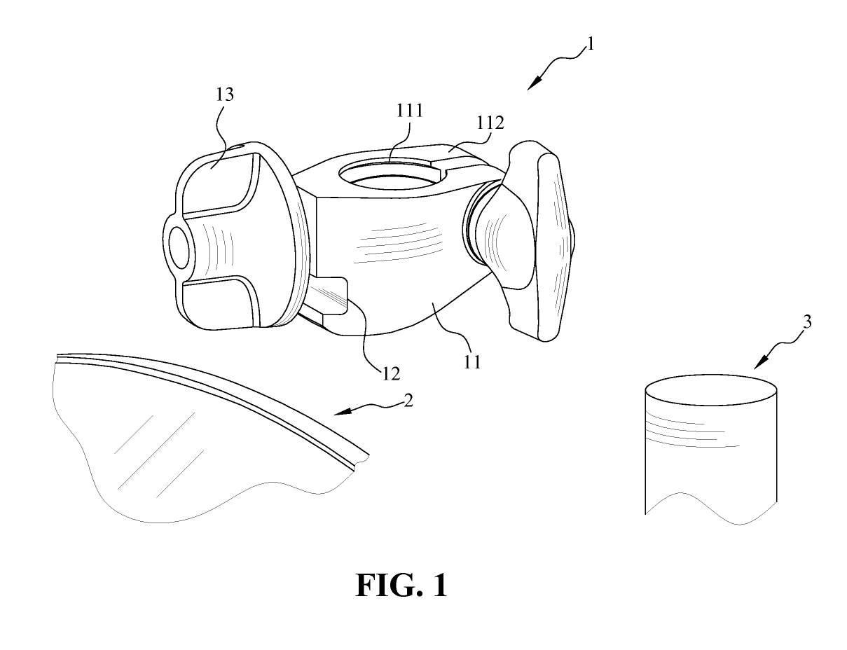

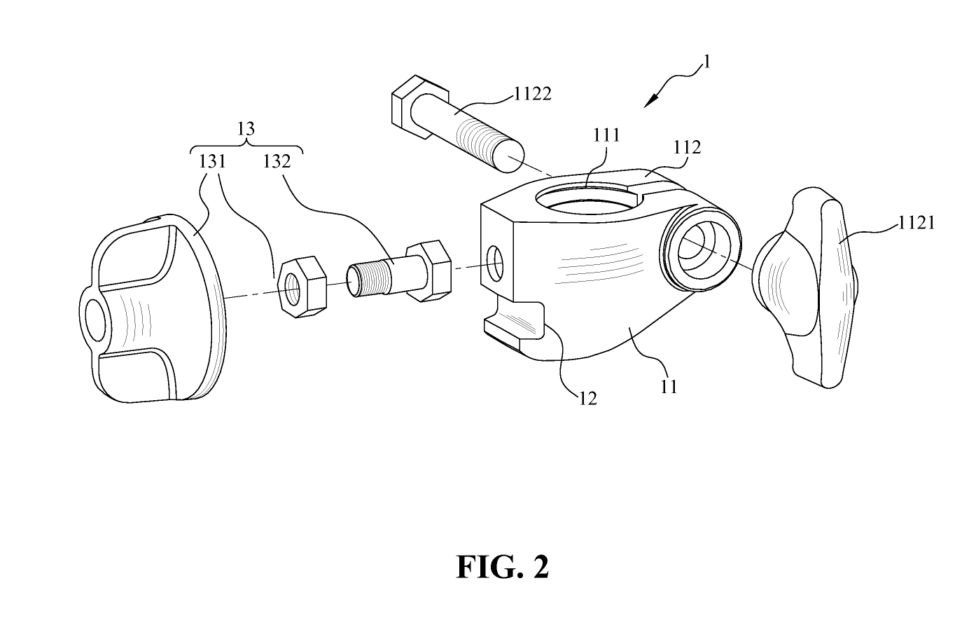

FIG. 1 is a perspective view showing the light reflector clamp 1 of the present invention; FIG. 2 is an exploded view showing the light reflector clamp 1 of the present invention. As shown in FIG. 1 and FIG. 2, the present invention is a light reflector clamp 1 for mounting a light reflector 2 with a rod member 3. The light reflector clamp 1 includes a central member 11, a groove 12 and a turning clamp set 13. A rod member clamping seat 111 is disposed on an appropriate portion of the central member 11, and a mounting portion 112 is disposed at an opening of the rod member clamping seat 111. The groove 12 is disposed on an appropriate portion of the central member 11, and the turning clamp set 13 is disposed on an appropriate portion of the central member 11 next to the groove 12. At least one of the light reflector clamp 1 is mounted on the rod member 3 via the rod member clamping seat 111. An edge of the light reflector 2 is fitted in the groove 12, and at least one of the turning clamp set 13 is utilized to fix the edge of the light reflector 12 with the at least one light reflector clamp 1.

It can be seen from FIG. 1 that the turning clamp set 13 includes a first female turning knob 131 and a first male screw 132. The first male screw 132 is mounted on the central member 11, and the first female turning knob 131 is engaged with the first male screw 132. In this way, the edge of the light reflector 2 is fixed between the groove 12 and the first female turning knob 131.

By fixing the light reflector 2 with the groove 12 and the first female turning knob 131, the light reflector 2 is less likely to fall off, and it is also less likely for the light reflector 2 to be damaged. To be more specific, the light reflector 2 is fixed between the groove 12 and the first female turning knob 131 by tightening the first female turning knob 131 toward the first male screw 132.

The mounting portion 112 further includes a second female turning knob 1121 and a second male screw 1122. The second female turning knob 1121 is engaged with the second male screw 1122 so as to mount the rod member clamping seat 111 with the rod member 3.

To be more specific, first, the rod member clamping seat 111 is sleeved around the rod member 3. Then, the second female turning knob 1121 is tightened toward the second male screw 1122 to tighten the opening of the rod member clamping seat 111. In this way, the rod member clamping seat 111 is mounted with the rod member 3.

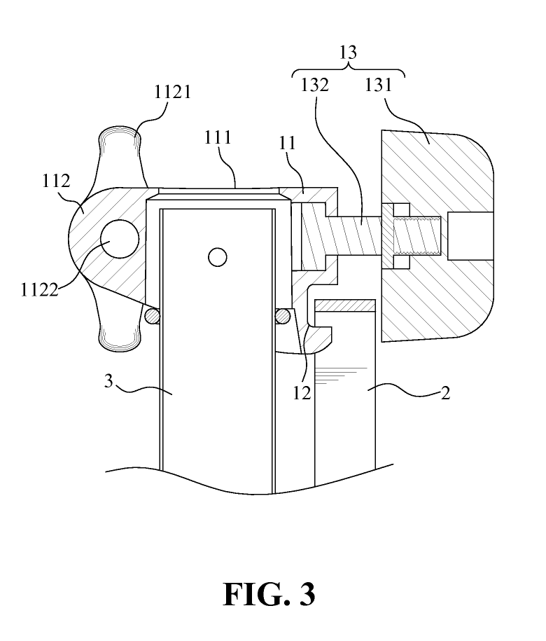

FIG. 3 is a section view showing the light reflector clamp 1 of the present invention. In the following section, an embodiment of the present invention is further explained with reference to FIG. 3. After the rod member clamping seat 111 is sleeved around the rod member 3, the second female turning knob 1121 is engaged with and tightened toward the second male screw 1122. The rod member clamping seat 111 is then tightened and clamps tightly with the rod member 3. The first male screw 132 is mounted inside the central member 11. The first female turning knob 131 is engaged with the exposed portion of the first male screw 132. After the first female turning knob 131 is tightened with the first male screw 132, the light reflector is fixed between the groove 12 and the first female turning knob 132. In addition, the shape of the groove 12 is configured corresponding to the shape of the edge of the light reflector, so the light reflector 2 is fixed between the groove 12 and the first female turning knob 131 in a more stable manner.

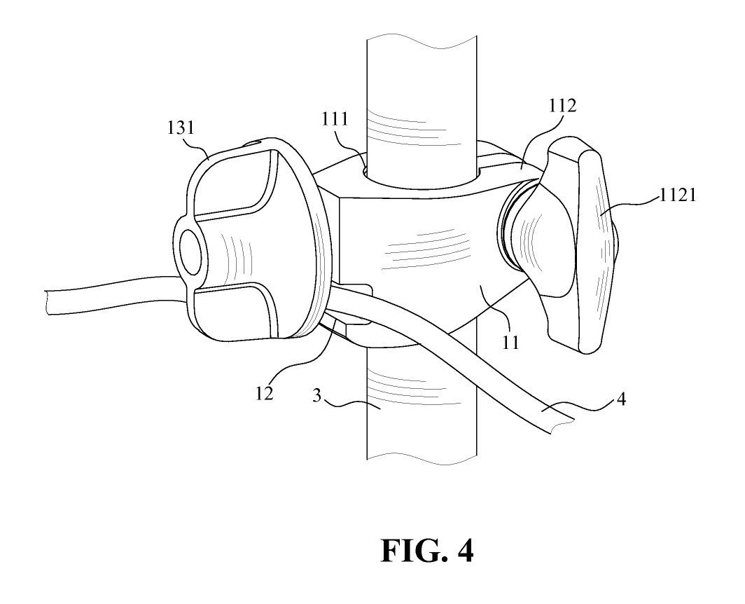

FIG. 4 is a perspective view showing the light reflector clamp according to a first embodiment of the present invention. In addition to clamping the light reflector 2, the present invention can also be used to mount wire sets 4 of lighting devices or other electronic equipments. As shown in FIG. 4, wire sets 4 can be fitted inside the groove 12, and can be restricted inside the groove 12 by tightening the first female turning knob 131.

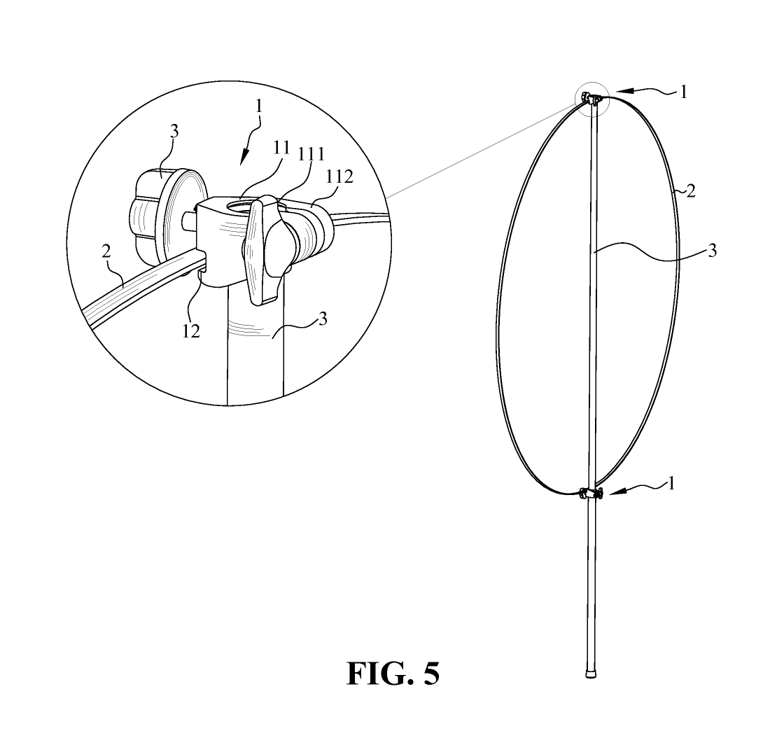

FIG. 5 is a perspective view showing the light reflector clamps according to a second embodiment of the present invention, which is also a preferred embodiment of the present invention. In the second embodiment, two of the light reflector clamps 1 are used to mount the light reflector 2. As shown in FIG. 5, the light reflector clamps 1 are mounted on any two opposite ends of the light reflector 2, and then the light reflector clamps 1 are mounted with the rod member 3. In this way, the light reflector 2 can be stably mounted with the rod member 3 via the light reflector clamps 1 provided by the present invention. The rod member 3 can be a tripod stand, which can be easily adjusted by the user.

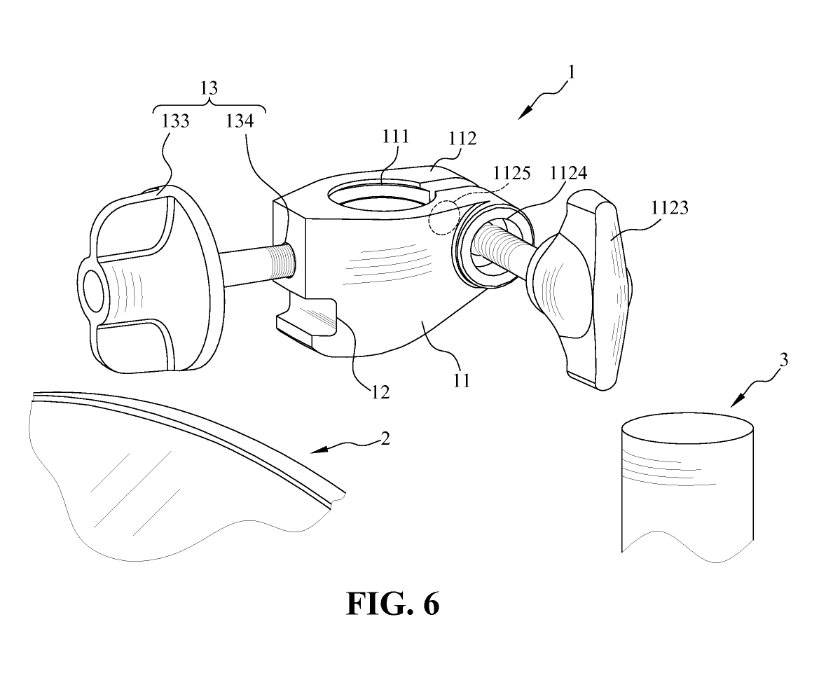

FIG. 6 is a perspective view showing the light reflector clamp according to a third embodiment of the present invention. As shown in FIG. 6, the turning clamp set 13 of the present invention can also be a first male turning knob 133. A first tapped hole 134 is disposed on the central member 11 next to the groove 12. The first male tuning knob 133 is engaged with the first tapped hole 134 so as to fix the edge of the light reflector 2 between the groove 12 and the first male turning knob 133.

According to the third embodiment, the mounting portion 112 further includes a second male turning knob 1123. A fitting hole 1124 is disposed on a side of the mounting portion 112, and a second tapped hole 1125 is disposed on another side of the mounting portion 112 corresponding to the fitting hole 1124. The second male turning knob 1123 is put through the fitting hole 1124 and is engaged with the second tapped hole 1125, thereby mounting the rod member clamping seat 111 with the rod member 3.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A light reflector clamp for mounting a light reflector with a rod member, comprising:
a central member, wherein a rod member clamping seat is disposed on the central member, and a mounting portion is disposed at an opening of the rod member clamping seat;
a groove, being disposed on the central member; and
a turning clamp set, being disposed on the central member next to the groove;
wherein at least one of the light reflector clamp is mounted on the rod member via the rod member clamping seat, an edge of the light reflector is fitted in the groove, and at least one of the turning clamp set is utilized to fix the edge of the light reflector with the at least one light reflector clamp.

2. The light reflector clamp according to claim 1, wherein the turning clamp set comprises a first female turning knob and a first male screw, wherein the first male screw is mounted on the central member, and the first female turning knob is engaged with the first male screw, thereby fixing the edge of the light reflector between the groove and the first female turning knob.

3. The light reflector clamp according to claim 1, wherein the mounting portion further comprises a second female turning knob and a second male screw, wherein the second female turning knob is engaged with the second male screw, thereby mounting the rod member clamping seat with the rod member.

4. The light reflector clamp according to claim 1, wherein the turning clamp set is a first male turning knob, and a first tapped hole is disposed on the central member next to the groove, wherein the first male tuning knob is engaged with the first tapped hole, so as to fix the edge of the light reflector between the groove and the first male turning knob.

5. The light reflector clamp according to claim 1, wherein the mounting portion further comprises a second male turning knob, a fitting hole is disposed on a side of the mounting portion, and a second tapped hole is disposed on another side of the mounting portion corresponding to the fitting hole; wherein the second male turning knob is put through the fitting hole and is engaged with the second tapped hole, so as to mount the rod member clamping seat with the rod member.

6. The light reflector clamp according to claim 1, wherein the shape of the groove is configured corresponding to the shape of the edge of the light reflector.
